(19) United States
(12) Patent Application Publication
(10) Pub. No.: US 2022/0047442 A1
(43) Pub. Date: Feb. 17, 2022

(54) CHAIRS FOR FACILITATING STRETCHING AND ACTIVE PHYSICAL MOVEMENT BY A USER

(71) Applicant: MyoHealth, LLC, Atlanta, GA (US)

(72) Inventors: Clifford Taylor, Atlanta, GA (US); Craig Taylor, Atlanta, GA (US); Tim Keepers, Atlanta, GA (US)

(21) Appl. No.: 17/403,568

(22) Filed: Aug. 16, 2021

Related U.S. Application Data
(60) Provisional application No. 63/065,835, filed on Aug. 14, 2020.

(51) Int. Cl. A61H 1/02; A47C 3/30; A47C 3/03; A47C 3/18; A47C 7/50

(52) U.S. Cl. CPC A61H 1/0218; A47C 3/30; A47C 3/03; A47C 3/18; A47C 7/50; A61H 2203/0431; A61H 2201/1253; A61H 2201/1635; A61H 2201/164; A61H 2201/1623; A61H 2201/0192; A61H 2201/0149

(57) ABSTRACT

A chair may include a base defining a vertical axis of the chair, a seat configured to support a user thereon, and a seat support assembly disposed between the base and the seat in the direction of the vertical axis. The seat support assembly may include a height adjustment assembly configured to allow the seat to translate along the vertical axis, and a wobble assembly configured to allow the seat to tilt relative to the vertical axis in a side-to-side direction. The wobble assembly may include a wobble lock having a locked configuration, in which the wobble lock inhibits tilting of the seat relative to the vertical axis in the side-to-side direction, and an unlocked configuration, in which the wobble lock allows tilting of the seat relative to the vertical axis in the side-to-side direction.

### CROSS-REFERENCE TO RELATED APPLICATIONS

This application claims priority to and the benefit of U.S. Provisional Patent Application No. 63/065,835, filed on Aug. 14, 2020, the disclosure of which is expressly incorporated herein by reference in its entirety.

### FIELD OF THE DISCLOSURE

The present disclosure relates generally to chairs and more particularly to chairs that facilitate stretching and active physical movement by a user and related methods of using such chairs to facilitate stretching and active physical movement.

### BACKGROUND OF THE DISCLOSURE

Various types of chairs may be used by individuals in different environments for different purposes. For example, a variety of chairs, such as ergonomic chairs, have been developed for use in work environments, including traditional office and home office settings, with such chairs being designed to increase efficiency and productivity of a user and to reduce user discomfort. Particular objectives for such chairs may include promoting proper posture to reduce the impact of repetitive movements while a user is working in a seated position for an extended period of time. Conventional chairs for work environments generally may include a base, a seat, a seatback, armrests, and a seat support structure that facilitates movement of the seat relative to the base. The seat support structure typically may allow for height adjustment of the seat along a vertical axis, rotation of the seat about the vertical axis, and front-to-back tilting of the seat relative to the vertical axis.

In many office environments, individuals often are seated and physically inactive for extended periods of time. Such sedentary behavior has been linked to numerous health problems, including, but not limited to, back pain, weight gain, blood clotting, heart issues, varicose veins, etc. Studies have shown that remaining in motion while at work may help to increase blood flow, which in turn may help to increase activity in the digestive system, which can lead to less weight gain and increased core engagement. Additionally, periodically engaging in stretching exercises or active physical motion while at work can increase energy levels, reduce soreness, and help to prevent muscle tightening, cramping, aches, and pains, particularly pain in the lower and upper back area. Back pain often may result from an individual remaining seated and physically inactive for extended periods of time, due to compression and dehydration of the spinal discs and loss of disc height. Such deleterious effects may lead to various spinal issues, including reduced spinal flexibility, as well as posture issues. Prolonged seating generally may lead to contracted, shortened, or tightened muscles. When the body is in motion, the resulting increased circulation may help lengthen contracted muscles as well as lubricate and apply nutrients to the joints. Studies have shown that sedentary behavior, without periodic motion, may result in an increased chance of spinal arthritis or osteoarthritis as well as early onset of osteoporosis or osteopenia due to a decrease in collagen and calcium production to the bones. An additional issue for those who remain seated for long periods of time is often referred to as “text neck” or “tech neck,” whereby the lordotic curvature of the cervical spine is lost due to poor posture and forward head translation. This can lead to tension headaches, tight shoulders, and rounding of the spine.

Fortunately, many of the above-noted problems associated with an individual remaining in a seated position for a prolonged period of time may be avoided or alleviated by periodic stretching and/or active physical movement. Without periodic stretching, many individuals may begin physical activity immediately after working in a seated position for 6 to 8 hours, which considerably increases chance of injury. Working out with contracted or shortened muscles that are anaerobic often may cause injuries. For these reasons, enabling individuals to engage in certain stretches and active movements while seated may present significant health benefits. Although conventional chairs may allow for some movement while an individual is seated on the chair, the types of movements possible may be limited and insufficient for purposes of maintaining the health of the spine and associated muscles as well as promoting blood circulation. Moreover, traditional chairs typically may not be well suited for stretching when an individual is in a seated position, lacking appropriate structure for supporting the individual during stretches or structure for the individual to grasp to facilitate stretching. As a result of these shortcomings, individuals may get up from their chair and leave their work environment when they seek to stretch or engage in active physical movement, often utilizing other equipment to facilitate such stretching or movement.

In contrast to chairs designed for work environments, certain therapeutic chairs have been developed to allow an individual to engage in various types of active movement. For example, “wobble chairs,” which often are used in chiropractic facilities, may be used to alleviate back pain and restore spinal flexibility. Certain wobble chairs generally may include a base, a seat, and a seat support structure that allows for height adjustment of the seat along a vertical axis, front-to-back tilting of the seat relative to the vertical axis, and side-to-side tilting of the seat relative to the vertical axis. Because wobble chairs typically are intended for only periodic use to facilitate therapeutic movements, they lack a seatback as well as means for selectively preventing tilting of the seat (i.e., a lock mechanism to prevent the front-to-back and side-to-side tilting motion of the seat). For at least these reasons, wobble chairs may not be suitable for prolonged use in a work environment.

A need therefore exists for improved chairs that facilitate stretching and active physical movement by a user while the user is in a seated position and immersed in the day-to-day office environment, which chairs may overcome one or more of the above-mentioned limitations associated with existing chairs.

### SUMMARY OF THE DISCLOSURE

The present disclosure provides chairs that facilitate stretching and active physical movement by a user and related methods of using such chairs to facilitate stretching and active physical movement. In one aspect, a chair is provided. In one embodiment, the chair may include a base, a seat, and a seat support assembly. The base may be configured to rest on a surface, and the base may define a vertical axis of the chair. The seat may be configured to support a user thereon. The seat support assembly may be disposed between the base and the seat in the direction of the vertical axis. The seat support assembly may include a height adjustment assembly configured to allow the seat to translate along the vertical axis, and a wobble assembly configured to allow the seat to tilt relative to the vertical axis in a side-to-side direction. The wobble assembly may include a wobble lock having a locked configuration, in which the wobble lock inhibits tilting of the seat relative to the vertical axis in the side-to-side direction, and an unlocked configuration, in which the wobble lock allows tilting of the seat relative to the vertical axis in the side-to-side direction.

In some embodiments, the wobble assembly also may be configured to allow the seat to tilt relative to the vertical axis in a front-to-back direction. The wobble lock may inhibit tilting of the seat relative to the vertical axis in the front-to-back direction when the wobble lock is in the locked configuration, and the wobble lock may allow tilting of the seat relative to the vertical axis in the front-to-back direction when the wobble lock is in the unlocked configuration. In some embodiments, the wobble assembly also may be configured to allow the seat to tilt relative to the vertical axis in a plurality of directions other than the side-to-side direction and the front-to-back direction. In some embodiments, the wobble lock may include a lock protrusion, and a wobble activation lever configured to move between a locked position, in which a portion of the wobble activation lever engages the lock protrusion, and an unlocked position in which the portion of the wobble activation lever is disengaged from the lock protrusion.

In some embodiments, the wobble assembly also may include a wobble housing, a wobble pin disposed at least partially within the wobble housing, and one or more resilient members disposed within the wobble housing and at least partially surrounding the wobble pin. The wobble pin may be configured to tilt relative to the wobble housing when the seat is tilted relative to the vertical axis, and the one or more resilient members may be configured to be resiliently deformed by the wobble pin when the seat is tilted relative to the vertical axis. In some embodiments, the wobble assembly may be disposed between the height adjustment assembly and the seat in the direction of the vertical axis. In some embodiments, the height adjustment assembly may include a hydraulic cylinder. In some embodiments, the height adjustment assembly may be coupled to the base in a manner such that the seat is configured to rotate about the vertical axis.

In some embodiments, the seat support assembly also may include a first tilt assembly configured to allow the seat to tilt relative to the vertical axis in a front-to-back direction while inhibiting tilting of the seat relative to the vertical axis in the side-to-side direction. The first tilt assembly may include a first tilt lock having a locked configuration, in which the first tilt lock inhibits tilting of the seat relative to the vertical axis in the front-to-back direction, and an unlocked configuration in which the first tilt lock allows tilting of the seat relative to the vertical axis in the front-to-back direction. In some embodiments, the first tilt assembly may be disposed between the height adjustment assembly and the wobble assembly in the direction of the vertical axis. In some embodiments, the seat support assembly also may include a second tilt assembly configured to allow the seat to tilt relative to the vertical axis in the front-to-back direction while inhibiting tilting of the seat relative to the vertical axis in the side-to-side direction. The second tilt assembly may include a second tilt lock having a locked configuration, in which the second tilt lock inhibits tilting of the seat relative to the vertical axis in the front-to-back direction, and an unlocked configuration in which the second tilt lock allows tilting of the seat relative to the vertical axis in the front-to-back direction. In some embodiments, the second tilt assembly may be disposed between the wobble assembly and the seat in the direction of the vertical axis. In some embodiments, the first tilt assembly may be configured to allow the seat to tilt relative to the vertical axis in the front-to-back direction over a first range of motion, and the second tilt assembly may be configured to allow the seat to tilt relative to the vertical axis in the front-to-back direction over a second range of motion that is different from the first range of motion.

In some embodiments, the chair also may include a seatback configured to support the user's back thereon, and a pair of armrests configured to support the user's arms thereon. The seatback may be coupled to the seat and configured to tilt along with the seat relative to the vertical axis in the side-to-side direction. The armrests may be coupled to the seat and configured to tilt along with the seat relative to the vertical axis in the side-to-side direction. In some embodiments, the chair also may include an extension arm assembly configured to be removably coupled to the base. The extension arm assembly may be configured to extend upward from the base and away from the seat when the extension arm assembly is coupled to the base. The extension arm assembly may include a pair of handles configured to be grasped by the user's hands.

In another aspect, a chair is provided. In one embodiment, the chair may include a base, a seat, a seat support assembly, and an extension arm assembly. The base may be configured to rest on a surface, and the base may define a vertical axis of the chair. The seat may be configured to support a user thereon. The seat support assembly may be disposed between the base and the seat. The seat support assembly may include a height adjustment assembly configured to allow the seat to translate along the vertical axis, and a tilt assembly configured to allow the seat to tilt relative to the vertical axis in a front-to-back direction. The tilt assembly may include a tilt lock having a locked configuration, in which the tilt lock inhibits tilting of the seat relative to the vertical axis in the front-to-back direction, and an unlocked configuration, in which the tilt lock allows tilting of the seat relative to the vertical axis in the front-to-back direction. The extension arm assembly may be configured to be removably coupled to the base. The extension arm assembly may be configured to extend upward from the base and away from the seat when the extension arm assembly is coupled to the base. The extension arm assembly may include a pair of handles configured to be grasped by the user's hands.

In some embodiments, the extension arm assembly may include a plurality of pins, and the base may include a plurality of holes configured to removably receive the pins therein when the extension arm assembly is coupled to the base. In some embodiments, the extension arm assembly also may include one or more leg support bars configured to support the user's legs thereon, and one or more foot support bars configured to support the user's feet thereon. In some embodiments, the base may include a hub centered on the vertical axis, a plurality of first legs extending outward from the hub, and a pair of second legs extending outward from the hub. Each first leg may have a first length from a base end to an opposite free end of the first leg, and each second leg may have a second length from a base end to an opposite free end of the second leg, with the second length being greater than the first length. In some embodiments, the base also may include a horizontal support extending between the free ends of the second legs.

These and other aspects and improvements of the present disclosure will become apparent to one of ordinary skill in the art upon review of the following detailed description when taken in conjunction with the several drawings and the appended claims.

### BRIEF DESCRIPTION OF THE DRAWINGS

FIG. 1A is a front perspective view of an example chair in accordance with one or more embodiments of the disclosure, the chair including a base, a seat, a seat support assembly, and an extension arm assembly shown in a use position.

FIGS. 1B and 1C are front perspective views of the chair of FIG. 1A, illustrating front-to-back tilting of the seat relative to a vertical axis of the chair.

FIGS. 1D and 1E are front perspective views of the chair of FIG. 1A, illustrating side-to-side tilting of the seat relative to the vertical axis of the chair.

FIG. 1F is a back perspective view of the chair of FIG. 1A, illustrating the extension arm assembly in a stowed position.

FIG. 1G is a back perspective view of the chair of FIG. 1A, illustrating a removable connection between the extension arm assembly and the base.

FIG. 1H is a back perspective view of the extension arm assembly of the chair of FIG. 1A, illustrating adjustment of the extension arm assembly.

FIG. 1I is a bottom perspective view of a portion of the seat support assembly of the chair of FIG. 1A, the seat support assembly including a seat base assembly, a height adjustment assembly, a wobble assembly in a locked configuration, a first tilt assembly in a locked configuration, and a second tilt assembly.

FIG. 1J is a bottom perspective view of a portion of the seat support assembly of the chair of FIG. 1A, illustrating the wobble assembly in the locked configuration and the first tilt assembly in an unlocked configuration.

FIG. 1K is a top perspective view of a portion of the seat support assembly of the chair of FIG. 1A, illustrating the wobble assembly in an unlocked configuration and the first tilt assembly in the locked configuration.

FIG. 1L is a side cross-sectional view of a portion of the seat support assembly of the chair of FIG. 1A, illustrating the wobble assembly in the locked configuration and the first tilt assembly in the locked configuration.

FIGS. 1M, 1N, and 1O are front perspective views of a user engaging in active physical movement using the chair of FIG. 1A.

FIGS. 1P and 1Q are front perspective views of a user stretching using the chair of FIG. 1A.

FIG. 2A is a side perspective view of an example chair in accordance with one or more embodiments of the disclosure, the chair including a base, a seat, a seat support assembly, and an extension arm assembly shown in a stowed position.

FIG. 2B is a side view of the chair of FIG. 2A.

FIG. 2C is a front view of the chair of FIG. 2A.

FIG. 2D is a bottom perspective view of the chair of FIG. 2A.

FIG. 2E is a side perspective view of the chair of FIG. 2A, illustrating the extension arm assembly in a use position.

FIG. 3 is a side perspective view of an example chair in accordance with one or more embodiments of the disclosure.

FIG. 4 is a side perspective view of an example chair in accordance with one or more embodiments of the disclosure.

FIG. 5A is a side perspective view of an example chair in accordance with one or more embodiments of the disclosure.

FIG. 5B is a side view of the chair of FIG. 5A positioned at a desk.

FIG. 6A is an exploded front perspective view of an example chair in accordance with one or more embodiments of the disclosure, the chair including a base, a seat, and a seat support assembly.

FIG. 6B is a back cross-sectional view of a portion of the seat support assembly of the chair of FIG. 6A, the seat support assembly including a seat base assembly, a height adjustment assembly, a wobble assembly in a locked configuration, and a tilt assembly.

FIG. 6C is a side cross-sectional view of a portion of the seat support assembly of the chair of FIG. 6A, illustrating the wobble assembly in the locked configuration.

FIG. 6D is a back view of a portion of the chair of FIG. 6A, illustrating the wobble assembly in an unlocked configuration and side-to-side tilting of the seat relative to a vertical axis of the chair.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION OF THE DISCLOSURE

In the following description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional. In some instances, well known methods, procedures, and components have not been described in detail so as not to unnecessarily obscure aspects of the embodiments.

Overview

Embodiments of chairs that facilitate stretching and active physical movement by a user and related methods of using such chairs are provided herein. The chairs generally may include a base, a seat, a seatback, and a seat support assembly that facilitates movement of the seat relative to the base. The seat support assembly may allow for height adjustment of the seat along a vertical axis, rotation of the seat about the vertical axis, and front-to-back tilting of the seat relative to the vertical axis.

In some embodiments, the seat support assembly advantageously also may allow for side-to-side tilting of the seat relative to the vertical axis, thereby enabling a user to engage in active physical movements not possible with conventional chairs for work environments. As described herein, the seat support assembly may include a wobble assembly that is configured to allow the seat to tilt relative to the vertical axis in a side-to-side direction. In some embodiments, the wobble assembly may be configured to allow the seat to tilt relative to the vertical axis in any direction. As described herein, the wobble assembly may include a wobble lock having a locked configuration, in which the wobble lock inhibits tilting of the seat relative to the vertical axis in the side-to-side direction, and an unlocked configuration in which the wobble lock allows tilting of the seat relative to the vertical axis in the side-to-side direction. In this manner, in contrast to existing wobble chairs, the tilting functionality provided by the wobble assembly of the disclosed chairs may be selectively inhibited, allowing a user to engage in certain active physical movements, when desired, and then disable the tilting functionality when the user intends to simply sit in the chair.

In some embodiments, the chairs also may include an extension arm assembly that is configured to extend upward from the base and away from the seat, with the extension arm assembly advantageously assisting a user in stretching while in a seated position. As described herein, the extension arm assembly may include one or more handles configured to be grasped by the user's hands to facilitate stretching. In some embodiments, the extension arm assembly may include one or more leg supports configured to support the user's legs thereon while the user stretches. In some embodiments, the extension arm assembly may include one or more foot supports configured to support the user's feet thereon while the user stretches. In some embodiments, the extension arm assembly may be removably coupled to the base. In this manner, the extension arm assembly may be coupled to the base in a use position for stretching, when desired, and then removed from the base when the user intends to simply sit in the chair. In some embodiments, when removed, the extension arm assembly may be removably coupled to another portion of the chair, such as along a back side of a seatback of the chair, in a stowed position. In this manner, the stowed extension arm assembly may be maintained out of the user's way while working but readily accessible for subsequent use. In some embodiments, the extension arm assembly may be fixedly coupled to the base, but the extension arm assembly may be configured to be extended from a stowed position to a use position and then retracted back to the stowed position.

Still other benefits and advantages of the chairs and related methods provided herein provided herein over existing chairs will be appreciated by those of ordinary skill in the art from the following description and the appended drawings.

Example Embodiments of Ergonomic Chairs

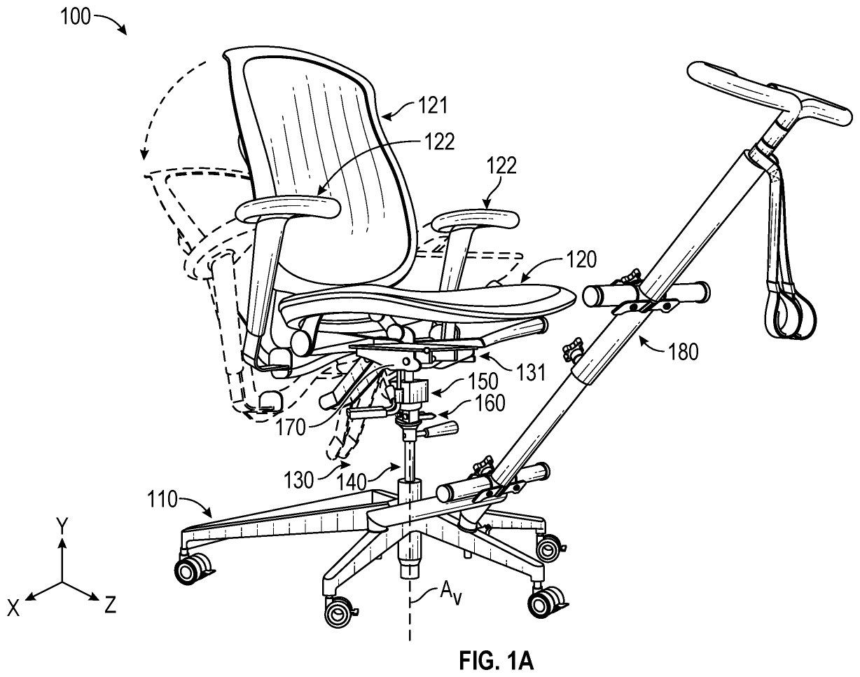

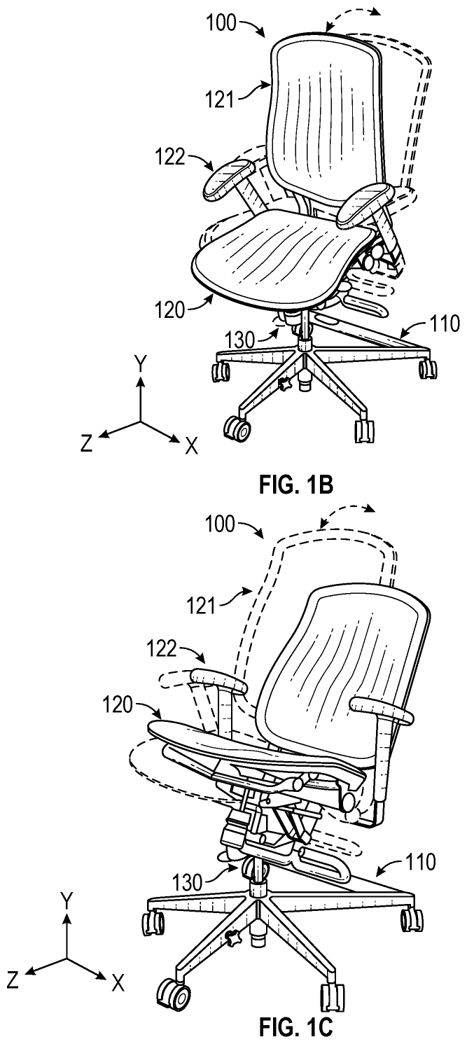

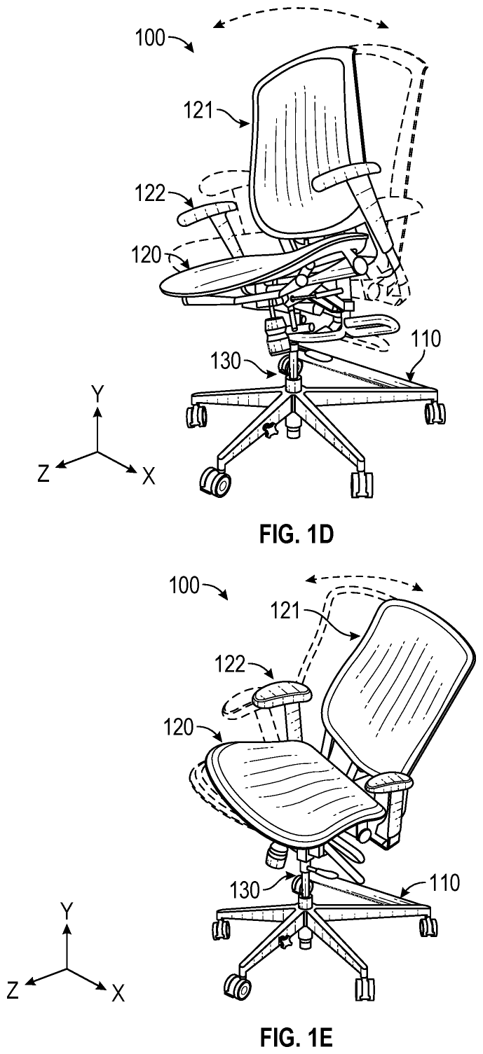

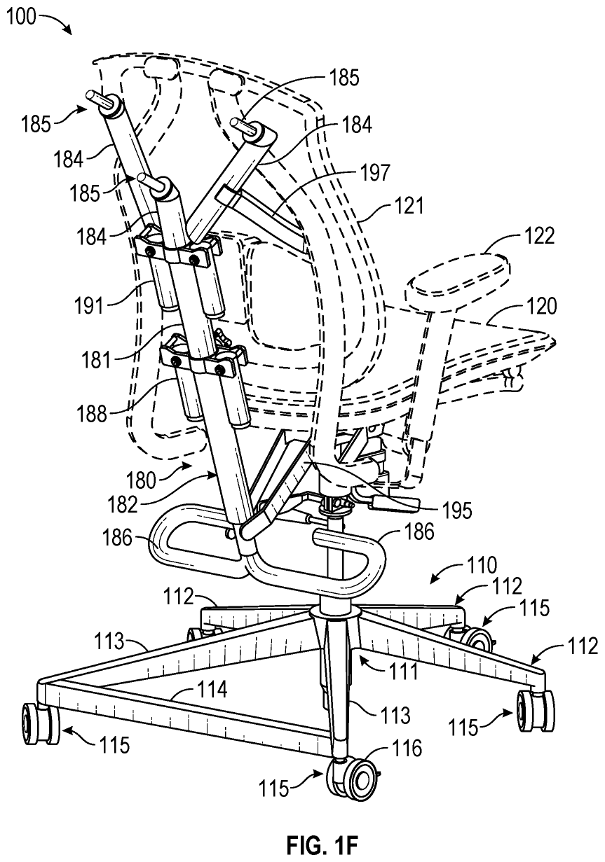

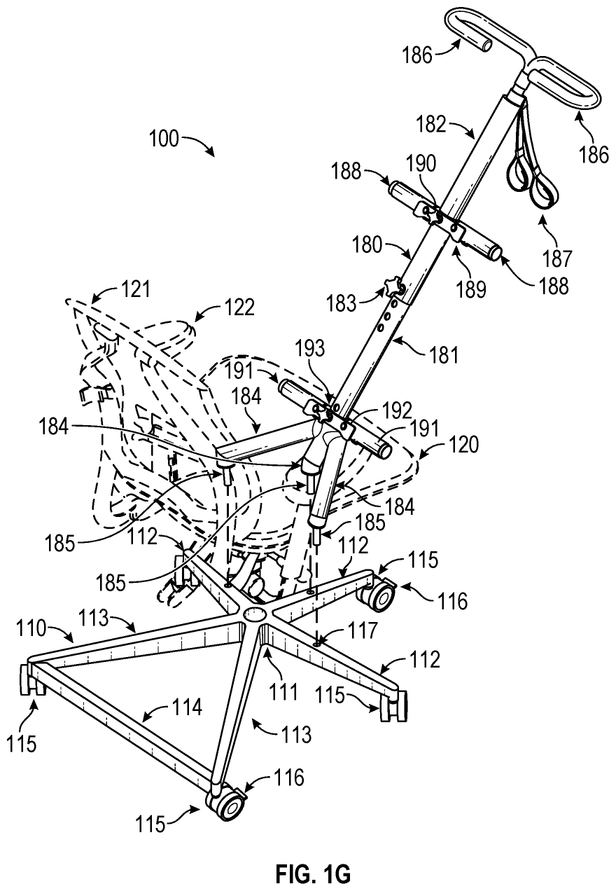

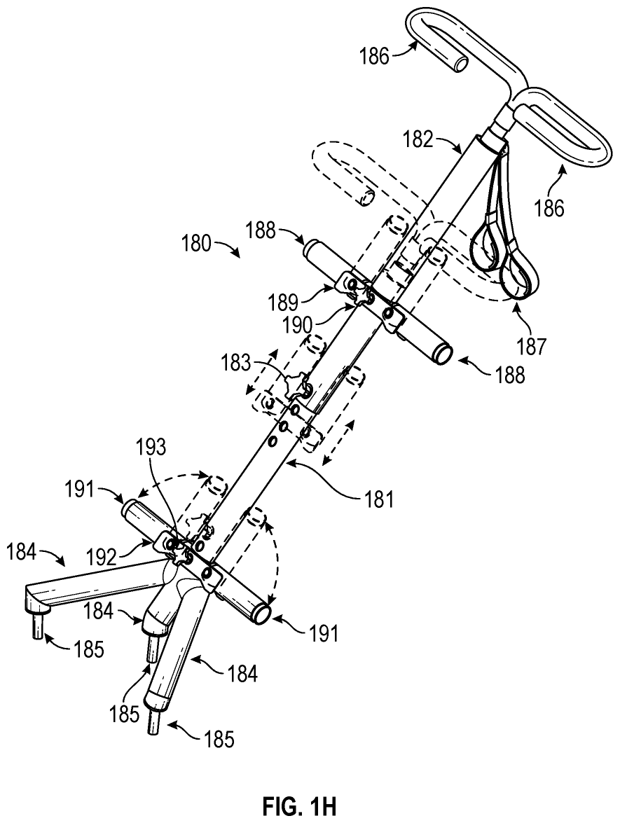

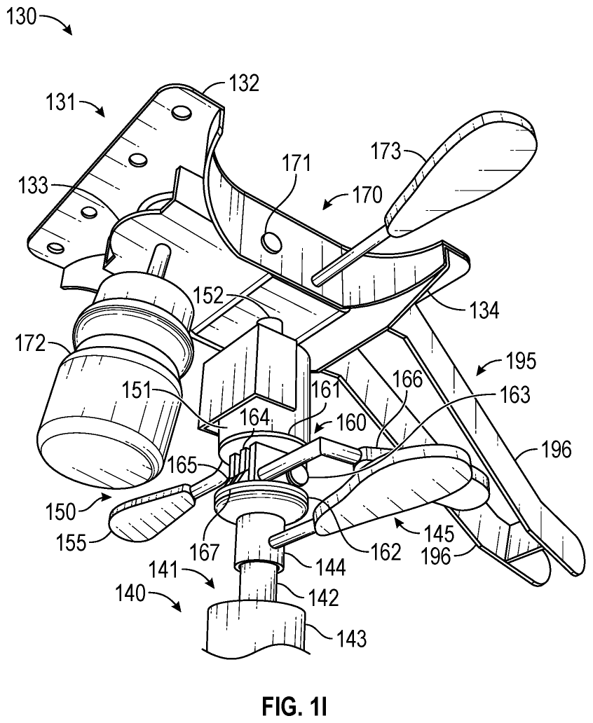

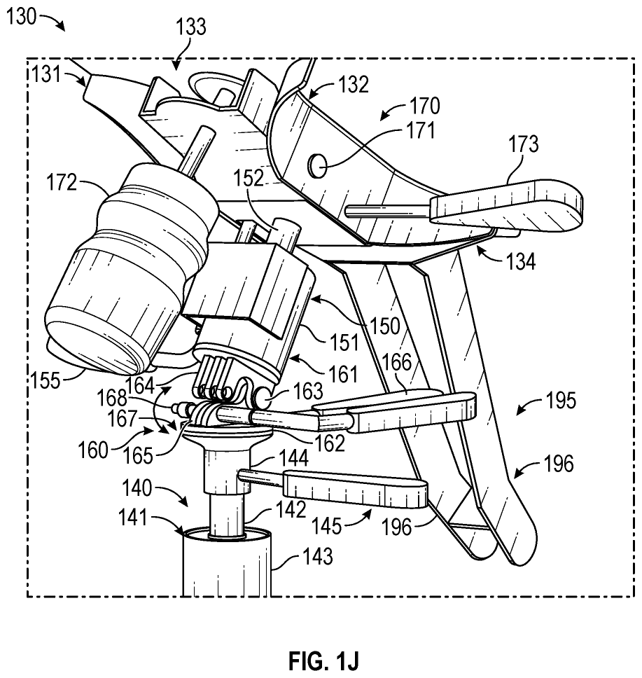

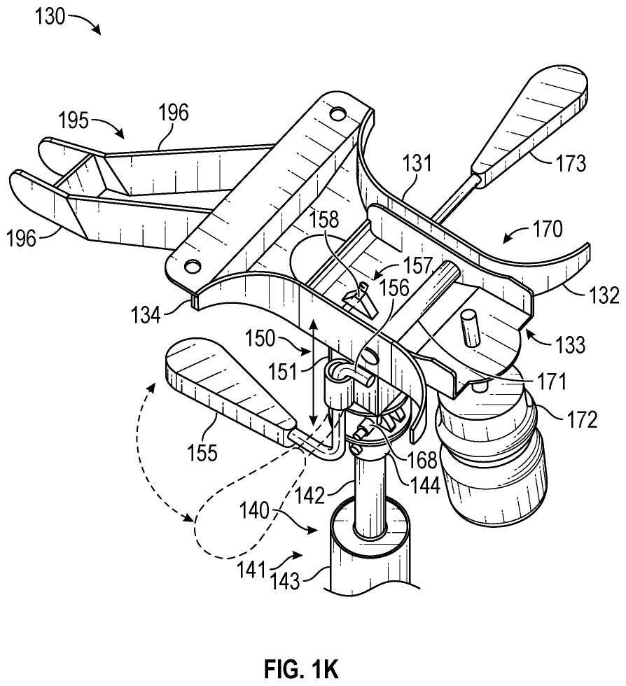

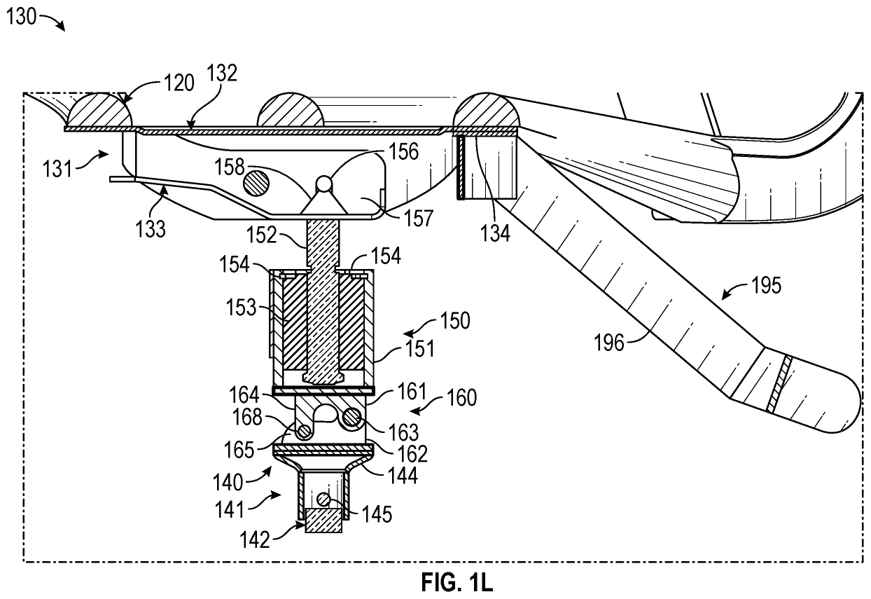

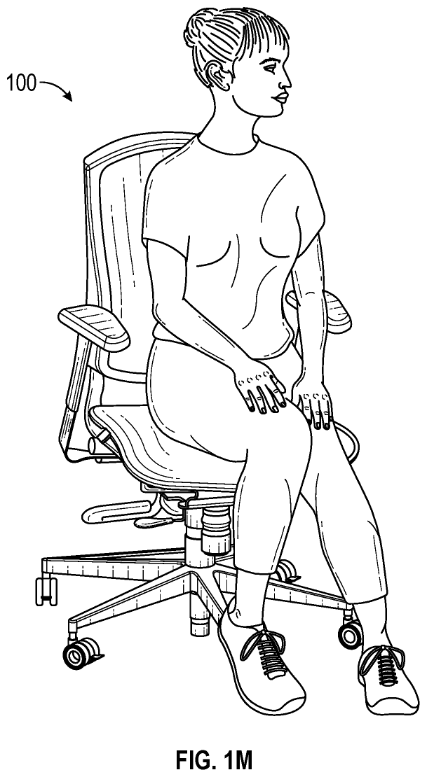

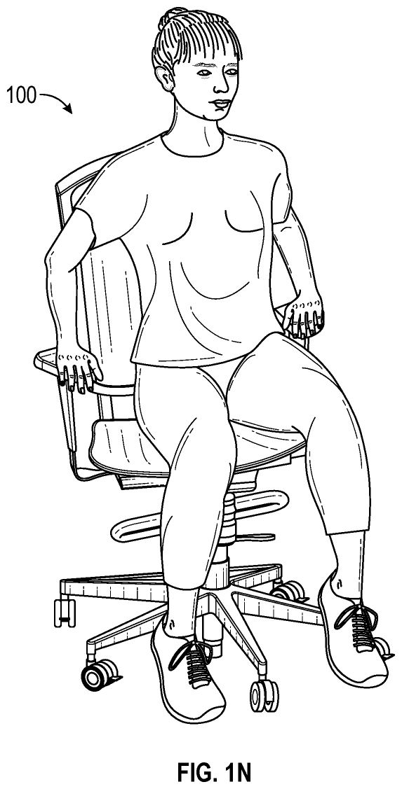

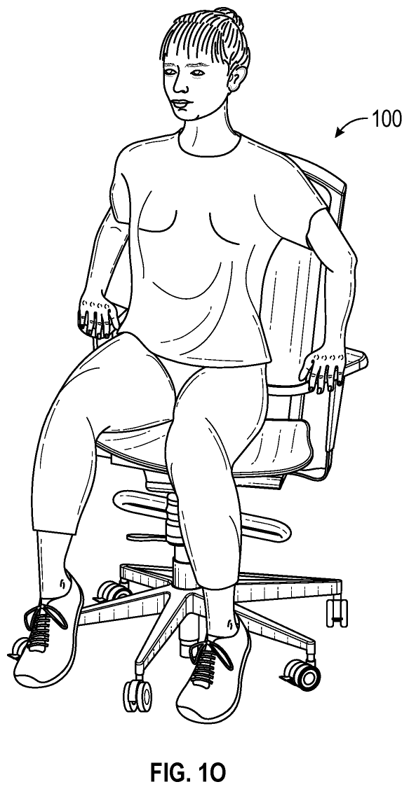

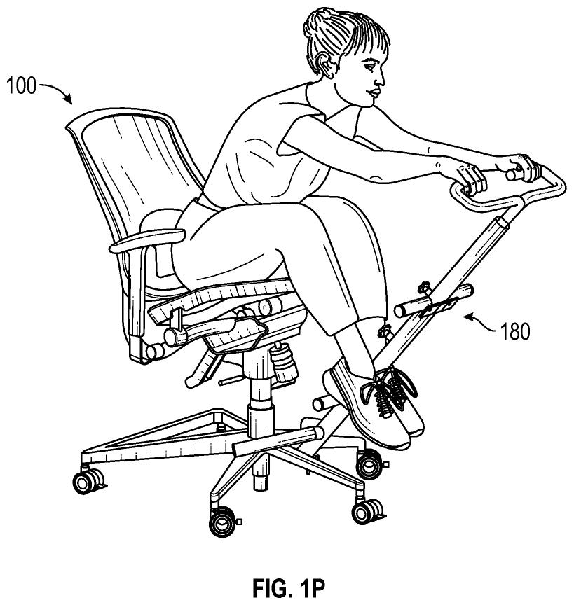

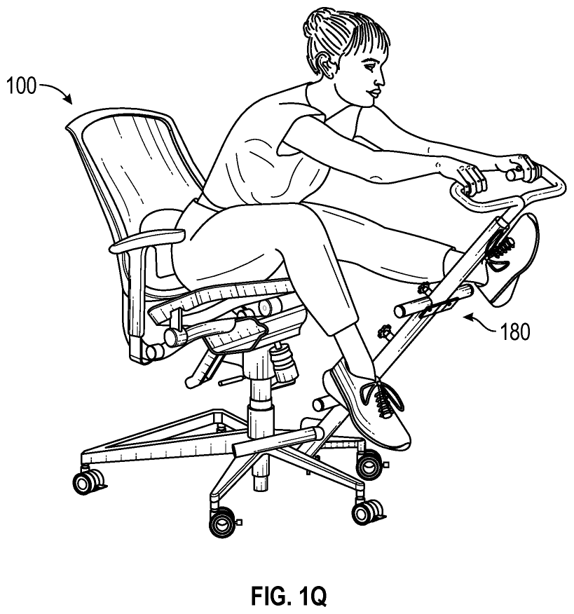

Referring now to FIGS. 1A-1Q, an example chair 100 (which also may be referred to as an “endostretch chair,” a “stretch chair,” an “active physical movement chair,” or an “ergonomic chair”) is depicted. As shown, the chair 100 may include a base 110, a seat 120, a seat support assembly 130, and an extension arm assembly 180. The base 110 may be configured to rest on a surface, such as a floor of a building in which the chair 100 is used, with the base 110 defining a vertical axis A_{V} of the chair 100 (extending in the Y direction, as shown). The seat 120 may be configured to support a user thereon. As shown, the seat support assembly 130 may be disposed between the base 110 and the seat 120 in the direction of the vertical axis A_{V}. As described below, the seat support assembly 130 may be configured to allow the seat 120 to translate along the vertical axis A_{V} for height adjustment, to rotate 360 degrees about the vertical axis A_{V}, to tilt relative to the vertical axis A_{V} in a front-to-back direction (within the Y-Z plane, as shown), and to tilt relative to the vertical axis A_{V} in a side-to-side direction (within the X-Y plane, as shown). Such motions of the seat 120 may allow a user to engage in various active physical movements while seated in the chair 100. As described below, the extension arm assembly 180 may include respective portions configured to be grasped by a user and/or to support the user's legs or feet. In this manner, the extension arm assembly 180 may allow a user to engage in various stretching exercises while seated in the chair 100.

The base 110 may include a hub 111 centered on the vertical axis A_{V} of the chair 100, and a plurality of legs extending outward from the hub 111. In some embodiments, the base 110 may include a plurality of first legs 112 and a plurality of second legs 113 having a different length than the first legs 112. As shown, the base 110 may include three of the first legs 112 each having a first length, and two of the second legs 113 each having a second length that is greater than the first length. During use of the chair 100 for stretching, the longer second legs 113 may be oriented along the back side of the chair 100, thereby enhancing stability of the chair 100 and safety for the user. In some embodiments, the base 110 also may include a horizontal support 114 extending between the second legs 113, which may provide additional stability. In some embodiments, the base 110 also may include a plurality of wheels 115, with one wheel 115 coupled about the free end of each of the legs 112, 113. Each wheel 115 may include a wheel lock 116 to selectively inhibit rotation of the wheel 115. In some embodiments, each of the first legs 112 may include a hole 117 configured to allow the extension arm assembly 180 to be removably coupled to the base 110, as described below.

The seat 120 may have any type of configuration suitable for supporting a user thereon. In some embodiments, as shown, the seat 120 may include a frame portion formed of one or more rigid materials, and a user engagement portion that is supported by the frame portion and formed of one or more flexible materials. In some embodiments, as shown, the chair 100 also may include a seatback 121 configured to support the user's back thereon, and a pair of armrests 122 configured to support the user's arms thereon. Similar to the seat 120, the seatback 121 may include a frame portion formed of one or more rigid materials, and a user engagement portion that is supported by the frame portion and formed of one or more flexible materials. Each of the seatback 121 and the armrests 122 may be coupled to the seat 120, either fixedly or removably, by one or more support members. In this manner, the seatback 121 and the armrests 122 may move along with the seat 120 as the seat 120 translates, rotates, or tilts relative to the vertical axis A_{V} of the chair 100.

The seat support assembly 130 may include multiple assemblies or subassemblies for supporting the seat 120 and allowing motion of the seat 120 relative to the vertical axis A_{V} of the chair 100 and thus relative to the base 110 and the surface upon which the base 110 rests. As shown, the seat support assembly 130 may include a seat base assembly 131, a height adjustment assembly 140, a wobble assembly 150, a first tilt assembly 160, and a second tilt assembly 170.

The seat base assembly 131 may be configured to support and directly interface with the seat 120. As shown, the seat base assembly 131 may include a first seat base plate 132 (which also may be referred to as a “first seat base member”), a second seat base plate 133 (which also may be referred to as a “second seat base member”), and a third seat base plate 134 (which also may be referred to as a “third seat base member”) coupled to one another. The first seat base plate 132 may be fixedly coupled to the seat 120, such as the frame portion thereof, by one or more fasteners. The second seat base plate 133 may be pivotally coupled to the first seat base plate 132, as described below. The third seat base plate 134 may be fixedly coupled to the first seat base plate 132, for example, by welding.

The height adjustment assembly 140 may be configured to allow the seat 120 to translate along the vertical axis A_{V} of the chair 100, enabling a height of the seat 120 to be adjusted by a user. As shown, the height adjustment assembly 140 may include a height adjustment cylinder 141, a height adjustment cap 144, and a height adjustment activation lever 145. The height adjustment cylinder 141 may include a height adjustment piston 142 that is configured to translate relative to a height adjustment housing 143. In some embodiments, as shown, the height adjustment cylinder 141 may be a hydraulic cylinder. The height adjustment activation lever 145 may be actuated by a user in a conventional manner to adjust the height of the seat 120, for example, by the user pulling upward on the lever 145. As shown, the height adjustment activation lever 145 may include a shaft extending into the height adjustment cap 144 for interfacing with the height adjustment cylinder 141 and a handle for engagement by a user. In some embodiments, the height adjustment assembly 140 may be rotatably coupled to the base 110 in a manner such that the seat 120 is configured to rotate about the vertical axis A_{V}.

The wobble assembly 150 may be configured to allow the seat 120 to tilt relative to the vertical axis A_{V} of the chair 120 in a front-to-back direction (within the Y-Z plane), as shown in FIGS. 1B and 1C, in a side-to-side direction (within the X-Y plane), as shown in FIGS. 1D and 1E, as well as any other direction therebetween. As shown, the wobble assembly 150 may include a wobble housing 151, a wobble pin 152 disposed at least partially within the wobble housing 151, and one or more resilient members 153 disposed within the wobble housing 151 and at least partially surrounding the wobble pin 152. In some embodiments, as shown, a single resilient member 153 may be used, although multiple resilient members 153 may be used in other embodiments. As shown, the resilient member 153 may have an annular shape, and the wobble pin 152 may extend through a central opening of the resilient member 153. As shown, the wobble pin 152 may be fixedly coupled to the second seat base plate 133 of the seat base assembly 131. The wobble pin 152 may be configured to tilt relative to the wobble housing 151 to allow the seat 120 to tilt relative to the vertical axis A_{V} of the chair 120, and the resilient member 153 may be configured to be resiliently deformed by the wobble pin 152 as the wobble pin 152 tilts relative to the wobble housing 151. In this manner, the resilient member 153 may resist tilting of the wobble pin 152 and bias the wobble pin 152 toward a home position aligned with the vertical axis A_{V} of the chair 120. As shown in FIG. 1L, the wobble assembly 150 may include one or more retention rings 154 configured to inhibit separation of the wobble pin 152 and the resilient member 153 from the wobble housing 151. In some embodiments, as shown, two retention rings 154 may be used, although a single retention ring 154 may be used in other embodiments. As shown, a first retention ring 154 may be received within an external circumferential groove of the wobble pin 152 and may abut a first end surface of the resilient member 153, and a second retention ring 154 may be received within an internal circumferential groove of the wobble housing 151 and may abut a second end surface of the resilient member 153. In some embodiments, as shown, the wobble pin 152 may include a flange disposed at or near the free end thereof, with the flange having an outer diameter larger than the inner diameter of the central opening of the resilient member 153 to inhibit separation of the components.

The wobble assembly 150 also may include a wobble lock 157 having a locked configuration, as shown in FIGS. 1I, 1J, and 1L, in which the wobble lock 157 inhibits tilting of the seat 120 via the wobble assembly 150 relative to the vertical axis A_{V} of the chair 100, and an unlocked configuration, as shown in FIG. 1K, in which the wobble lock 157 allows tilting of the seat 120 via the wobble assembly 150 relative to the vertical axis A_{V}. In some embodiments, as shown, the wobble lock 157 may include a wobble activation lever 155 and a lock protrusion 158. The wobble activation lever 155 may be configured to move between a locked position, in which a locking portion 156 of the wobble activation lever 155 engages the lock protrusion 158, and an unlocked position in which the locking portion 156 is disengaged from the lock protrusion 156. In some embodiments, the wobble activation lever 155 may be configured to rotate between the locked position and the unlocked position, as shown in FIG. 1K. In some embodiments, as shown, the lock protrusion 158 may be fixedly coupled to the second seat base plate 133 of the seat base assembly 131. As shown, the wobble activation lever 155 may include a shaft extending through the seat base assembly 131 for interfacing with the lock protrusion 158 and a handle for engagement by a user, with the shaft including the locking portion 156. Various other configurations of the wobble lock 157 may be used in other embodiments.

The first tilt assembly 160 may be configured to allow the seat 120 to tilt relative to the vertical axis A_{V} of the chair 100 in a front-to-back direction (within the Y-Z plane), as shown in FIGS. 1A and 1J, while inhibiting tilting of the seat 120 relative to the vertical axis A_{V} in the side-to-side direction (within the X-Y plane). As shown, the first tilt assembly 160 may include a first tilt body 161 and a second tilt body 162 pivotally coupled to one another via a first tilt pin 163. The first tilt body 161 may be configured to pivot relative to the second tilt body 162 between a closed position, as shown in FIGS. 1I and 1L, and an open position, as shown in FIG. 1J. The first tilt body 161 may include a plurality of first fingers 164, and the second tilt body 162 may include a plurality of second fingers 165 configured to interdigitate with the first fingers 164 when the first tilt body 161 is in the closed position. In some embodiments, as shown, the first tilt body 161 may be fixedly coupled to the wobble housing 151 of the wobble assembly 150, for example, by welding or one or more fasteners, and the second tilt body 162 may be fixedly coupled to the height adjustment cap 144 of the height adjustment assembly 140, for example, by welding or one or more fasteners.

The first tilt assembly 160 also may include a first tilt lock 167 having a locked configuration, as shown in FIGS. 1I and 1L, in which the first tilt lock 167 inhibits tilting of the seat 120 via the first tilt assembly 160 relative to the vertical axis A_{V} of the chair 100, and an unlocked configuration, in which the first tilt lock 167 allows tilting of the seat 120 via the first tilt assembly 160 relative to the vertical axis A_{V}. In some embodiments, as shown, the first tilt lock 167 may include a first tilt activation lever 166 and a locking pin 168. The first tilt activation lever 166 and the locking pin 168 may be configured to move between a locked position, in which the first tilt activation lever 166 and the locking pin 168 each engage respective openings of the first fingers 164 and the second fingers 165, and an unlocked position in which the first tilt activation lever 166 and the locking pin 168 are disengaged from the openings. In some embodiments, the first tilt activation lever 166 and the locking pin 168 each may be configured to translate between the locked position and the unlocked position, as shown in FIG. 1J. As shown, the first tilt activation lever 166 may include a shaft for extending through the respective openings of the first fingers 164 and the second fingers 165 and a handle for engagement by a user. Various other configurations of the first tilt lock 167 may be used in other embodiments.

The second tilt assembly 170 may be configured to allow the seat 120 to tilt relative to the vertical axis A_{V} of the chair 100 in a front-to-back direction (within the Y-Z plane) while inhibiting tilting of the seat 120 relative to the vertical axis A_{V} in the side-to-side direction (within the X-Y plane). As shown, the second tilt assembly 170 may be formed in a conventional manner, with a second tilt pin 171 pivotally coupling the first seat base plate 132 and the second seat base plate 134 to one another, and a tension knob 172 configured to allow a user to adjust tension of the tilting movement provided by the second tilt assembly 170. As shown, the second tilt assembly 170 also may include a second tilt activation lever 173, which may be formed in a conventional manner. In some embodiments, the second tilt assembly 170 may include a second tilt lock having a locked configuration, in which the second tilt lock inhibits tilting of the seat 120 via the second tilt assembly 170 relative to the vertical axis of the chair 100, and an unlocked configuration, in which the second tilt lock allows tilting of the seat 120 via the second tilt assembly 170. The second tilt lock, which may include the second tilt activation lever 173, may be formed in a conventional manner and may be moved between the locked configuration and the unlocked configuration by moving the second tilt activation lever 173 between a locked position and an unlocked position. Various other configurations of the second tilt lock may be used in other embodiments. In some embodiments, the first tilt assembly 160 may be configured to allow the seat 120 to tilt relative to the vertical axis of the chair 100 over a first range of motion, and the second tilt assembly 170 may be configured to allow the seat 120 to tilt relative to the vertical axis over a second range of motion that is different from the first range of motion. As shown, the second range of motion may be less than the first range of motion. In this manner, the first tilt assembly 160 may be used when a greater range of tilting is desired, for example, when the users wishes to perform stretching exercises, while the second tilt assembly 170 may be used when a lesser range of tilting is desired, for example, during normal use of the chair 100 while the user is working in a seated position.

The extension arm assembly 180 may include various features configured to be grasped by a user and/or to support the user's legs or feet to facilitate stretching exercises while the user is seated in the chair 100. As shown, the extension arm assembly 180 may include a first tube 181, a second tube 182, a pair of handles 186, a pair of leg support bars 188, and a pair of foot support bars 191. The first tube 181 and the second tube 182 may be arranged in a telescoping manner such that the second tube 182 may be translated relative to the first tube 181. In this manner, an overall length of the extension arm assembly 180 may be adjusted to accommodate different users. In some embodiments, as shown, a first knob 183 may be included to lock the first tube 181 and the second tube 182 relative to one another. As shown, the first knob 183 may extend through an opening of one of the tubes 181, 182 and engage one of a plurality of mating openings in the other of the tubes 181, 182. In some embodiments, a tip of the first knob 183 may be threaded, and the mating openings may be threaded to provide a secure connection therebetween.

The handles 186 may be configured to be grasped by the user's hands. As shown, the handles 186 may be coupled, either fixedly or removably, to the second tube 182. In some embodiments, as shown, the extension arm assembly 180 also may include a pair of wrist straps 187, which may be coupled, either fixedly or removably, to the handles 186 or the second tube 182. The leg support bars 188 may be configured to support the user's legs thereon. As shown, the leg support bars 188 may be coupled to the second tube 182 by a leg support bracket 189 and a second knob 190. In some embodiments, the leg support bars 188 each may be pivotally coupled to the leg support bracket 189 and configured to pivot between a stowed position and a use position, as shown in FIG. 1H. The second knob 190 may allow a position of the leg support bracket 189 (and thus the leg support bars 188 coupled thereto) along the second tube 182 to be adjusted to accommodate different users. The foot support bars 191 may be configured to support the user's feet thereon. As shown, the foot support bars 191 may be coupled to the first tube 181 by a foot support bracket 192 and a third knob 193. In some embodiments, the foot support bars 191 each may be pivotally coupled to the foot support bracket 192 and configured to pivot between a stowed position and a use position, as shown in FIG. 1H. The third knob 193 may allow a position of the foot support bracket 192 (and thus the foot support bars 191 coupled thereto) along the first tube 181 to be adjusted to accommodate different users.

In some embodiments, as shown, the extension arm assembly 180 may be configured to be removably coupled to the base 110. In this manner, the extension arm assembly 180 may be coupled to the base 110 in a use position, as shown in IA, for stretching, when desired, and then removed from the base 110 when the user intends to simply sit in the chair 100. In some embodiments, as shown, the extension arm assembly 180 may include three support legs 184 each fixedly coupled to the first tube 181 and each including a pin 185 configured to be removably received within the holes 117 of the first legs 112 of the base 110. In some embodiments, one or more locks may be provided to selectively secure the pins 185 within the holes 117 and inhibit removal of the extension arm assembly 180 from the base 110. Various other means for removably coupling the extension arm assembly 180 to the base 110 may be used in other embodiments. In some embodiments, when the extension arm assembly 180 is removed from the base 110, the extension arm assembly 180 may be removably coupled to another portion of the chair 110 in a stowed position. For example, the extension arm assembly 180 may be removably coupled along a back side of the seatback 121 in a stowed position, as shown in FIG. 1F. In this manner, the stowed extension arm assembly 180 may be maintained out of the user's way while working but readily accessible for subsequent use. As shown, the extension arm assembly 180 may be removably coupled to a support arm assembly 195 and a pair of clamp arms 197. In some embodiments, the support arm assembly 195 may include a pair of support arms 196 configured to removably receive a base of the handles 186 therebetween, and each clamp arm 197 may be configured to removably receive one of the support legs 184. Various other configurations of structures for retaining the extension arm assembly 180 in a stowed position may be used in other embodiments. In some instances, a user may wish to keep the extension arm assembly 180 coupled to the base 110 while the extension arm assembly 180 is not being used for stretching. In such instances, the seat 120 may be rotated 180 degrees relative to the base 110, such that the extension arm assembly 180 is positioned behind the seatback 121 and out of the user's way while working. Then, the seat 120 may be rotated back to a position in which the extension arm assembly 180 is in front of the seat 120 when use of the extension arm assembly 180 for stretching is desired.

FIGS. 1M-1O illustrate a user engaging in example active physical movements using the chair 100. FIG. 1M shows the user in a seated, working position. FIG. 1N shows the user engaging in a hip tilt to the user's right side, while FIG. 1O shows the user engaging in a hip tilt to the user's left side. It will be appreciated that the illustrated active physical movements are merely examples, and that various other types of active physical movements are possible using the chair 100. FIGS. 1P and 1Q illustrate a user engaging in example stretching exercises using the chair 100. FIG. 1P shows the user performing a back stretch using the chair 100, with the user grasping the handles 186 and the user's feet resting on the foot support bars 191. FIG. 1Q shows the user performing a back and leg stretch using the chair 100, with the user grasping the handles 186, one of the user's feet resting on one of the foot support bars 191, and one of the user's legs resting on one of the leg support bars 188. It will be appreciated that the illustrated stretches are merely examples, and that various other types of stretching exercises are possible using the chair 100.

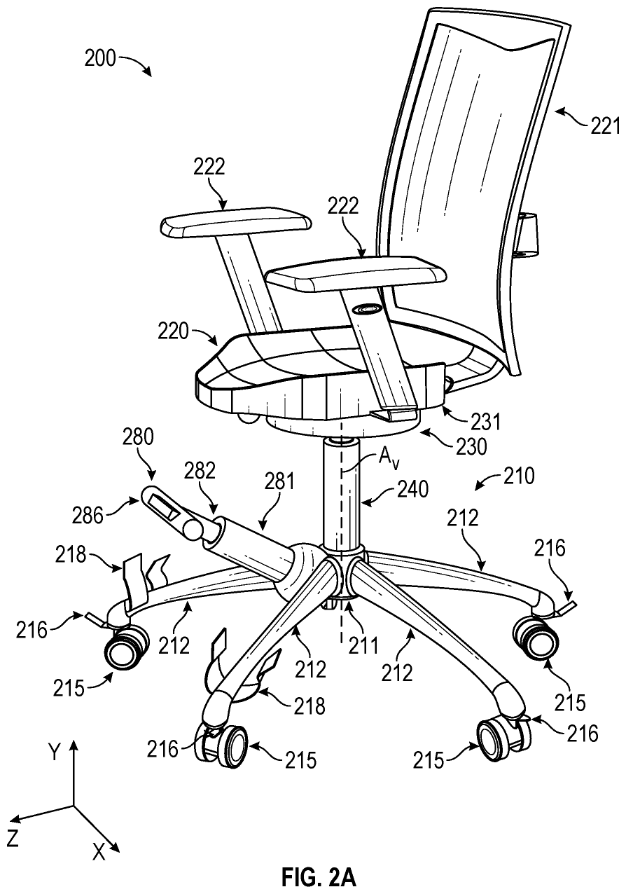

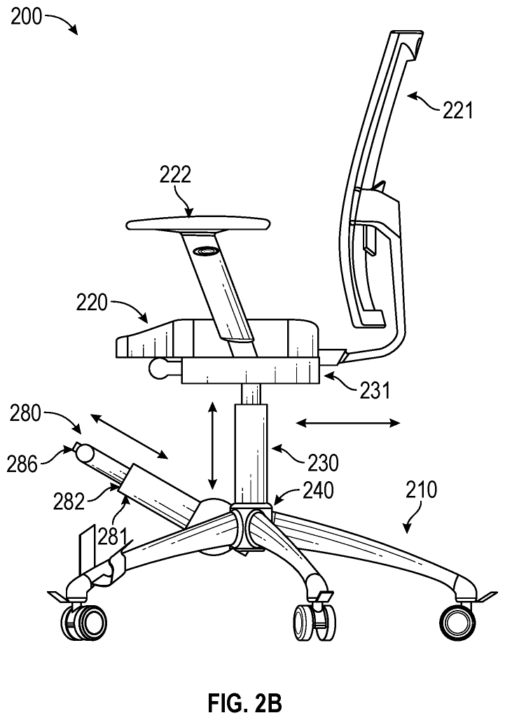

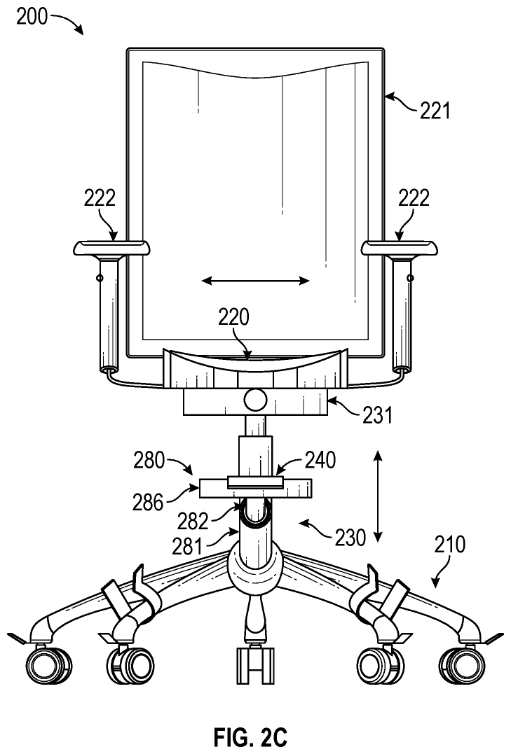

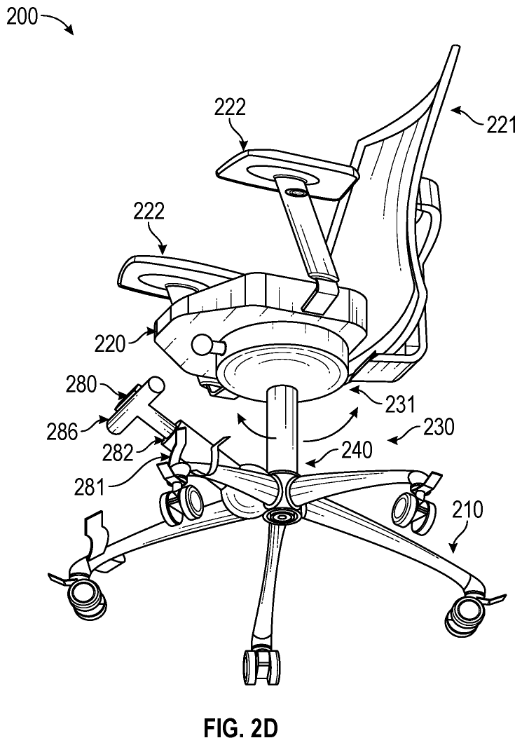

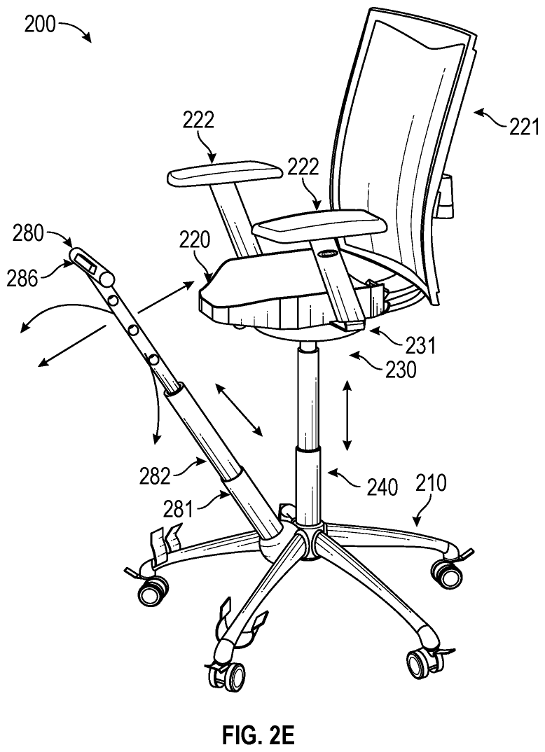

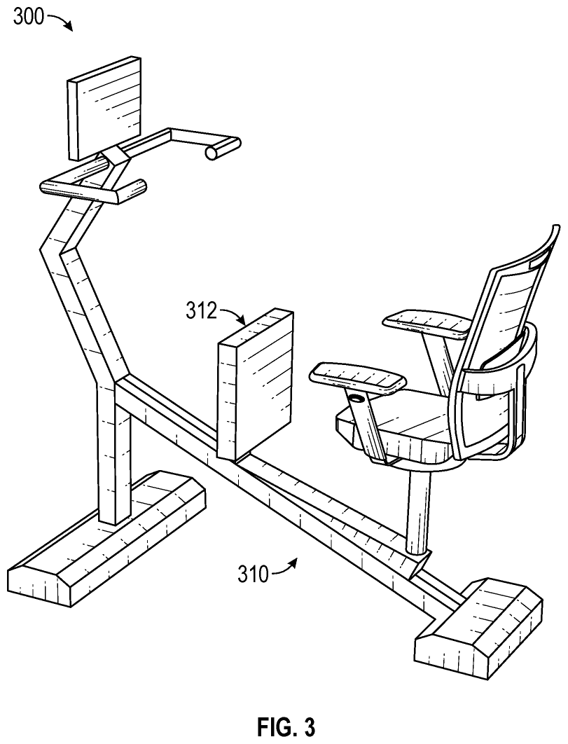

FIGS. 2A-2E depict another example chair 200 (which also may be referred to as an “endostretch chair,” a “stretch chair,” an “active physical movement chair,” or an “ergonomic chair”). Certain similarities and differences between the chair 200 and the chair 100 described above will be appreciated from the drawings and the following description. Corresponding reference numbers are used for corresponding features, which generally may be configured in a manner similar to the features described above unless indicated otherwise. As shown, the chair 200 may include a base 210, a seat 220, a seatback 221, armrests 222, a seat support assembly 230, and an extension arm assembly 280. The base 210 may be configured to rest on a surface, such as a floor of a building in which the chair 200 is used, with the base 210 defining a vertical axis A_{V} of the chair 200. The seat 220 may be configured to support a user thereon. As shown, the seat support assembly 230 may be disposed between the base 210 and the seat 220 in the direction of the vertical axis A_{V}. The seat support assembly 230 may be configured to allow the seat 220 to translate along the vertical axis A_{V} for height adjustment, to rotate 360 degrees about the vertical axis A_{V}, and to tilt relative to the vertical axis A_{V} in a front-to-back direction (within the Y-Z plane, as shown). The extension arm assembly 280 may include respective portions configured to be grasped by a user and/or to support the user's legs or feet. In this manner, the extension arm assembly 280 may allow a user to engage in various stretching exercises while seated in the chair 200.

The base 210 may include a hub 211 centered on the vertical axis A_{V} of the chair 200, and a plurality of legs 212 extending outward from the hub 211. The base 210 also may include a plurality of wheels 215 each having a wheel lock 216. In some embodiments, as shown, the base 210 also may include two or more straps 218 coupled to respective legs 212. The straps 218 may be configured to secure the user's feet or ankles to the base 210 while the user stretches.

The seat support assembly 230 may include a seat base assembly 231 configured to support and directly interface with the seat 220. The seat support assembly 230 also may include a height adjustment assembly 240 configured to allow the seat 220 to translate along the vertical axis A_{V} of the chair 200 and to rotate about the vertical axis A_{V}.

The extension arm assembly 280 may include various features configured to be grasped by a user and/or to support the user's legs or feet to facilitate stretching exercises while the user is seated in the chair 200. As shown, the extension arm assembly 280 may include a first tube 281, a second tube 282, and a T-shaped handle 286. The first tube 281, the second tube 282, and the handle 286 may be arranged in a telescoping manner. In this manner, an overall length of the extension arm assembly 280 may be adjusted to accommodate different users. In some embodiments, as shown, the first tube 281 may be fixedly attached to the base 210, such as the hub 211 and/or one or more of the legs 212. In this manner, the extension arm assembly 280 may be extended and retracted between a use position, as shown in FIG. 2E, and a stowed position, as shown in FIG. 2A. In some instances, when the extension arm assembly 280 is in the stowed position, a user may rotate the seat 220 180 degrees relative to the base 110, such that the extension arm assembly 280 is positioned behind the seatback 221 and completely out of the user's way while working.

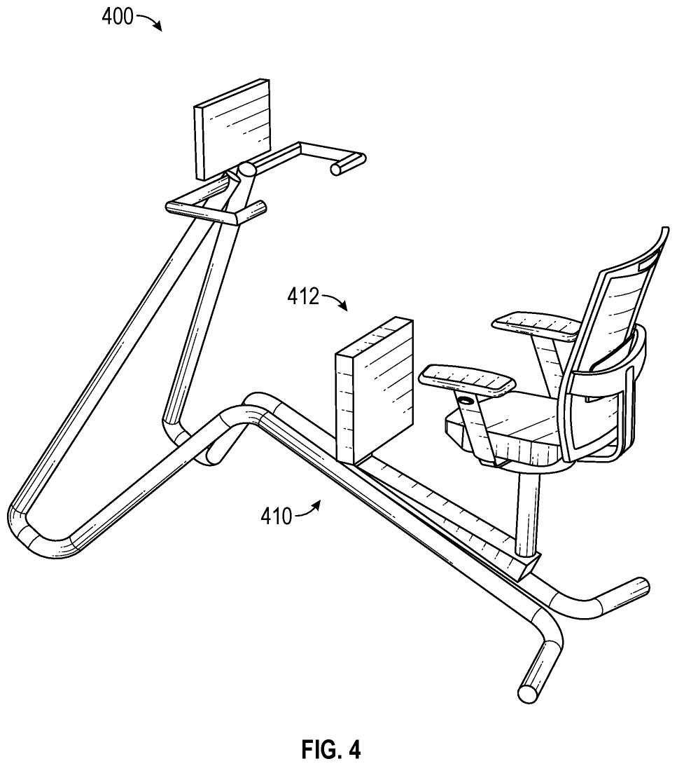

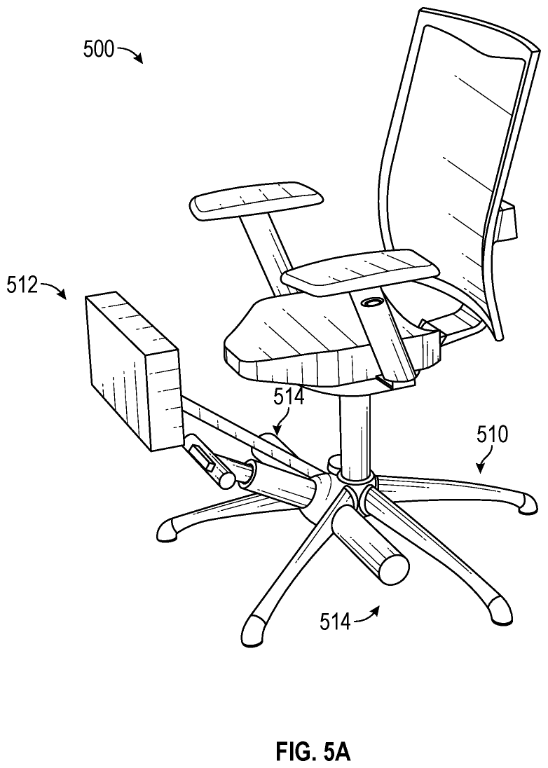

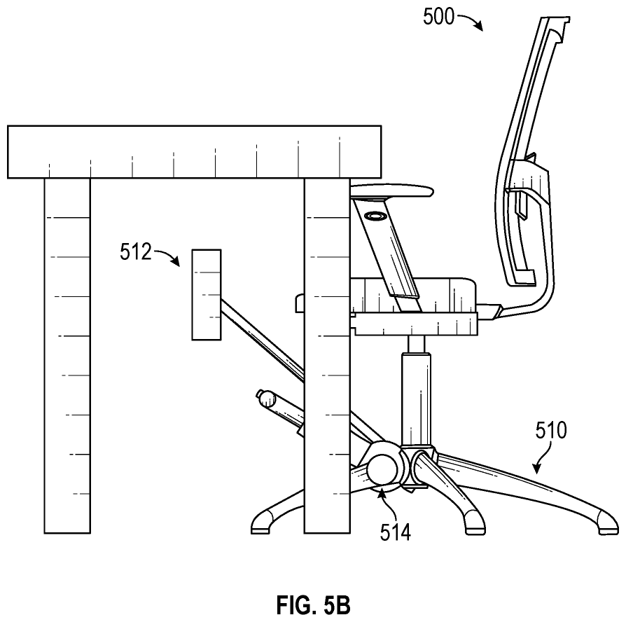

FIGS. 3-5B depict other examples of chairs 300, 400, 500 (each of which also may be referred to as an “endostretch chair,” a “stretch chair,” an “active physical movement chair,” or an “ergonomic chair”). Certain similarities and differences between the chairs 300, 400, 500 and the chair 200 described above will be appreciated from the drawings and the following description. As shown, the chairs 300, 400, 500 each include a base 310, 410, 510 that is intended to remain stationary with respect to a support surface during use of the chairs 300, 400, 500. Each base 310, 410, 510 includes a leg support 312, 412, 512 that is configured to support the user's legs thereon to facilitate stretching. The base 510 also includes a pair of foot supports 514 configured to support the user's feet thereon to facilitate stretching. It will be appreciated from the drawings that the chairs 300, 400, 500 each include a seat, a seatback, armrests, and a seat support assembly that are identical to the seat 220, the seatback 221, the armrests 222, and the seat support assembly 230 of the chair 200. Additionally, the chair 500 includes an extension arm assembly that is identical to the extension arm assembly 280 of the chair 200. FIG. 5B shows the chair 500 positioned at a desk, with the leg support 512 and the stowed extension arm assembly conveniently positioned under the desk.

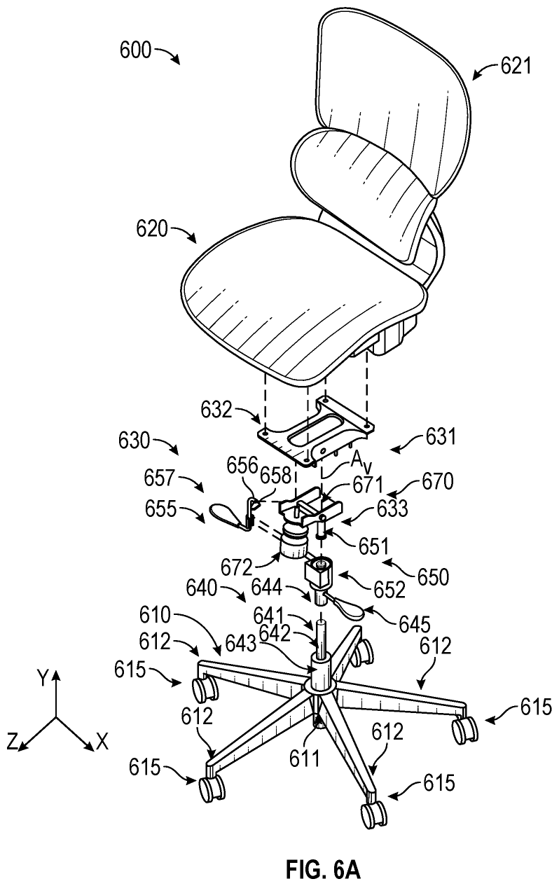

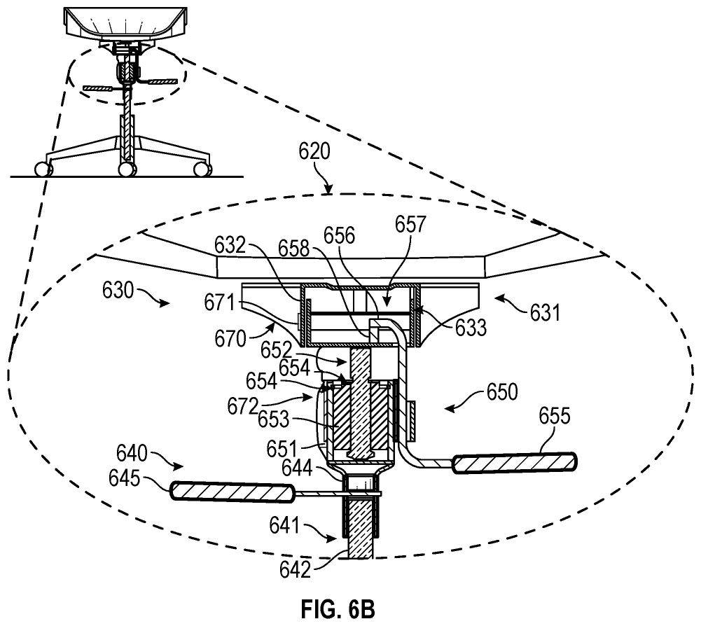

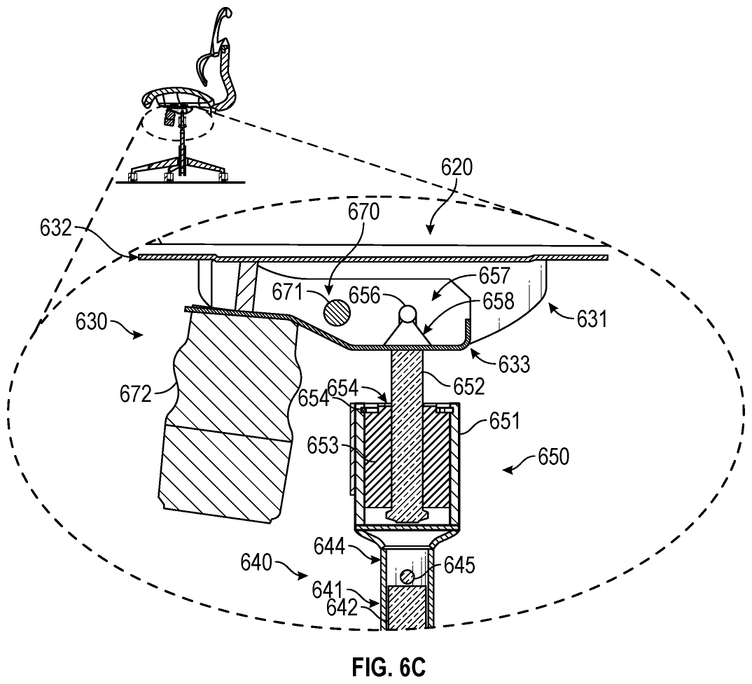

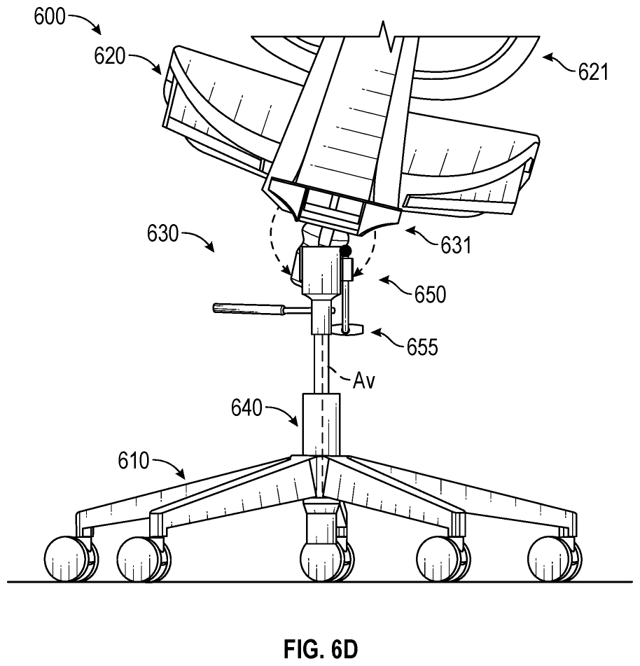

FIGS. 6A-6D depict another example ergonomic chair 600 (Which also may be referred to as an “endostretch chair,” a “stretch chair,” an “active physical movement chair,” or an “ergonomic chair”). Certain similarities and differences between the chair 600 and the chair 100 described above will be appreciated from the drawings and the following description. Corresponding reference numbers are used for corresponding features, which generally may be configured in a manner similar to the features described above unless indicated otherwise. As shown, the chair 600 may include a base 610, a seat 620, and a seat support assembly 630. The base 610 may be configured to rest on a surface, such as a floor of a building in which the chair 600 is used, with the base 610 defining a vertical axis A_{V} of the chair 600. The seat 620 may be configured to support a user thereon. As shown, the seat support assembly 630 may be disposed between the base 610 and the seat 620 in the direction of the vertical axis A_{V}. As described below, the seat support assembly 630 may be configured to allow the seat 620 to translate along the vertical axis A_{V} for height adjustment, to rotate 360 degrees about the vertical axis A_{V}, to tilt relative to the vertical axis A_{V} in a front-to-back direction (within the Y-Z plane), and to tilt relative to the vertical axis A_{V} in a side-to-side direction (within the X-Y plane). Such motions of the seat 620 may allow a user to engage in various active physical movements while seated in the chair 600.

The base 610 may include a hub 611 centered on the vertical axis A_{V} of the chair 600, and a plurality of legs 612 extending outward from the hub 611. In some embodiments, the base 610 also may include a plurality of wheels 615, with one wheel 615 coupled about the free end of each of the legs 612.

The seat 620 may have any type of configuration suitable for supporting a user thereon. In some embodiments, the seat 620 may include a frame portion formed of one or more rigid materials, and a user engagement portion that is supported by the frame portion and formed of one or more flexible materials. In some embodiments, as shown, the chair 600 also may include a seatback 621 configured to support the user's back thereon. Similar to the seat 620, the seatback 621 may include a frame portion formed of one or more rigid materials, and a user engagement portion that is supported by the frame portion and formed of one or more flexible materials. The seatback 621 may be coupled to the seat 620, either fixedly or removably, by one or more support members. In this manner, the seatback 621 may move along with the seat 620 as the seat 620 translates, rotates, or tilts relative to the vertical axis A_{V} of the chair 600.

The seat support assembly 630 may include multiple assemblies or subassemblies for supporting the seat 620 and allowing motion of the seat 620 relative to the vertical axis A_{V} of the chair 600 and thus relative to the base 610 and the surface upon which the base 610 rests. As shown, the seat support assembly 630 may include a seat base assembly 631, a height adjustment assembly 640, a wobble assembly 650, and a tilt assembly 670.

The seat base assembly 631 may be configured to support and directly interface with the seat 620. As shown, the seat base assembly 631 may include a first seat base plate 632 (which also may be referred to as a “first seat base member”) and a second seat base plate 633 (which also may be referred to as a “second seat base member”) coupled to one another. The first seat base plate 632 may be fixedly coupled to the seat 620, such as the frame portion thereof, by one or more fasteners. The second seat base plate 633 may be pivotally coupled to the first seat base plate 632, as described below.

The height adjustment assembly 640 may be configured to allow the seat 620 to translate along the vertical axis A_{V} of the chair 600, enabling a height of the seat 620 to be adjusted by a user. As shown, the height adjustment assembly 640 may include a height adjustment cylinder 641, a height adjustment cap 644, and a height adjustment activation lever 645. The height adjustment cylinder 641 may include a height adjustment piston 642 that is configured to translate relative to a height adjustment housing 643. In some embodiments, as shown, the height adjustment cylinder 641 may be a hydraulic cylinder. The height adjustment activation lever 645 may be actuated by a user in a conventional manner to adjust the height of the seat 620, for example, by the user pulling upward on the lever 645. As shown, the height adjustment activation lever 645 may include a shaft extending into the height adjustment cap 644 for interfacing with the height adjustment cylinder 641 and a handle for engagement by a user.

The wobble assembly 650 may be configured to allow the seat 620 to tilt relative to the vertical axis A_{V} of the chair 620 in a front-to-back direction (within the Y-Z plane), in a side-to-side direction (within the X-Y plane), as shown in FIG. 6D, as well as any other direction therebetween. As shown, the wobble assembly 650 may include a wobble housing 651, a wobble pin 652 disposed at least partially within the wobble housing 651, and one or more resilient members 653 disposed within the wobble housing 651 and at least partially surrounding the wobble pin 652. In some embodiments, as shown, a single resilient member 653 may be used, although multiple resilient members 653 may be used in other embodiments. As shown, the resilient member 653 may have an annular shape, and the wobble pin 652 may extend through a central opening of the resilient member 653. As shown, the wobble pin 652 may be fixedly coupled to the second seat base plate 633 of the seat base assembly 631. The wobble pin 652 may be configured to tilt relative to the wobble housing 651 to allow the seat 620 to tilt relative to the vertical axis A_{V} of the chair 600, and the resilient member 653 may be configured to be resiliently deformed by the wobble pin 652 as the wobble pin 652 tilts relative to the wobble housing 651. In this manner, the resilient member 653 may resist tilting of the wobble pin 652 and bias the wobble pin 652 toward a home position aligned with the vertical axis of the chair 620. As shown in FIGS. 6B and 6C, the wobble assembly 650 may include one or more retention rings 654 configured to inhibit separation of the wobble pin 652 and the resilient member 653 from the wobble housing 651. In some embodiments, as shown, two retention rings 654 may be used, although a single retention ring 654 may be used in other embodiments. As shown, a first retention ring 654 may be received within an external circumferential groove of the wobble pin 652 and may abut a first end surface of the resilient member 653, and a second retention ring 654 may be received within an internal circumferential groove of the wobble housing 651 and may abut a second end surface of the resilient member 653. In some embodiments, as shown, the wobble pin 652 may include a flange disposed at or near the free end thereof, with the flange having an outer diameter larger than the inner diameter of the central opening of the resilient member 653 to inhibit separation of the components.

The wobble assembly 650 also may include a wobble lock 657 having a locked configuration, as shown in FIGS. 6B and 6C, in which the wobble lock 657 inhibits tilting of the seat 620 via the wobble assembly 650 relative to the vertical axis A_{V} of the chair 600, and an unlocked configuration, as shown in FIG. 6D, in which the wobble lock 657 allows tilting of the seat 620 via the wobble assembly 650 relative to the vertical axis A_{V}. In some embodiments, as shown, the wobble lock 657 may include a wobble activation lever 655 and a lock protrusion 658. The wobble activation lever 655 may be configured to move between a locked position, in which a locking portion 656 of the wobble activation lever 655 engages the lock protrusion 658, and an unlocked position in which the locking portion 656 is disengaged from the lock protrusion 656. In some embodiments, the wobble activation lever 655 may be configured to rotate between the locked position and the unlocked position, as shown. In some embodiments, as shown, the lock protrusion 658 may be fixedly coupled to the second seat base plate 633 of the seat base assembly 631. As shown, the wobble activation lever 655 may include a shaft extending through the seat base assembly 631 for interfacing with the lock protrusion 658 and a handle for engagement by a user, with the shaft including the locking portion 656. Various other configurations of the wobble lock 657 may be used in other embodiments.

The tilt assembly 670 may be configured to allow the seat 620 to tilt relative to the vertical axis of the chair 600 in a front-to-back direction (within the Y-Z plane) while inhibiting tilting of the seat 620 relative to the vertical axis in the side-to-side direction (within the X-Y plane). As shown, the second tilt assembly 670 may be formed in a conventional manner, with a tilt pin 671 pivotally coupling the first seat base plate 632 and the second seat base plate 633 to one another, and a tension knob 672 configured to allow a user to adjust tension of the tilting movement provided by the tilt assembly 670.

As discussed above, a user in a work environment may seek to inject periodic activity into his or her work schedule to help improve overall wellness. In order to facilitate the user's objective, the user may substitute his or her traditional office chair with one of the chairs provided herein. The following describes example stretching exercises and active physical movements that the user may engage in with one or more of the disclosed chairs. It will be appreciated that some of these exercises or movements may be possible with only some, and not necessarily all, of the above-described chairs.

Using the chair, at periodic intervals (e.g., every 30 minutes, every hour, every two hours, etc.), the user may lock the wheels, strap his or her ankles down with the ankle straps or otherwise secure the user's ankles or feet, and perform several minutes of stretching exercises without leaving his or her immediate office area. Stretching exercises may include torso rotations, lower back leans, etc. Moreover, the user may unlock the wheels of the base and unstrap his or her ankles, such that the user can perform lower back side stretches where the user may move the chair laterally (side to side) while keeping his or her chest in a substantially stationary position. From this position, the user may also choose to engage in leg stretches by keeping his or her feet planted on the floor, grabbing the extendable handle, and pushing the chair backward such that the user's legs are straightened. Further, from this position, the user may engage in hamstring stretches by lifting a straightened leg off the floor such that the user's leg is parallel to the floor. Additionally, the user may stretch his or her gluteal and/or hip muscles by resting one leg in a crossed position atop the other thigh, while grabbing the extendable handle and pushing the chair backward. Moreover, with the wheels remaining unlocked, the user may engage in inner thigh and groin stretches by grabbing the extendable handle, placing both feet on the edge of the seat such that his or her legs are in a “butterfly” position, and pushing the chair backward.

Further, the user may re-strap his or her ankles, extend the extendable handle, and unlock a slidable motion component of the seat support assembly, such that the user may perform seated row exercises from the comfort of his or her office (e.g., by grabbing the T-bar of the extendable handle and sliding the seat back and forth while in a sitting position). Additionally, from this position, the user may re-engage the wheel locks and perform seated crunches to facilitate the strengthening of the user's core muscle group.

According to additional exercises available to the chair, the user may remove the seatback and position the seat of the chair such that it teeters in the center of the seat support assembly, whereby the user can conduct additional core strengthening exercises. With the user's ankles unstrapped and his or her arms not supported by the armrests, the user may balance and lean in a variety of directions with a 360 degree range of motion. Additionally, this unlocked position with the seatback removed minimizes external support, such that the user may focus on increasing balance and improving posture. To further enhance the user's experience, in various embodiments, the user may include weights, resistance bands, or other third party equipment in the activity.

Additionally, and in some embodiments, in conjunction with one or more of the above described exercises and/or stretches, a user of the chair may position his or her lower extremities (e.g., feet, knees, thighs, legs, calves, etc.) in a variety of ways. In one embodiment, a user may position at least one of his or her feet under the foot bars (or within straps), such that the foot bars (or straps or other device/mechanism) provide resistance to upward motion of the feet. In another embodiment, a user may position at least one of his or her feet on top of the foot bars to provide added stability and support. In certain embodiments, a user may place at least one of his or her knees on a leg stabilizing mechanism (e.g., one or more of the leg supports) when leaning forward or is otherwise in a crouching position. In at least one embodiment, a leg stabilizing mechanism may be repositioned such that a user whose feet are resting on the floor, or on top of the foot bars, may place his or her knees over the leg stabilizing mechanism (e.g., such that the back of the user's knees are resting against a leg stabilization mechanism). In some embodiments, the tops of the user's feet are against a bar, or the user's feet are held in place via one or more straps and the back of the user's knees are resting against a leg stabilization mechanism. In particular embodiments, a user may place his or her feet on the floor or on top of the foot bars, and a leg stabilizing mechanism may be positioned to rest against the user's shins for providing resistance to user leg extensions. In one or more embodiments, a leg stabilizing mechanism may be adjusted, such that a user may extend his or her legs and rest his or her calves on top of the leg stabilizing mechanism. The above described positions of a user's lower extremities are not intended to be exhaustive, as a user may position his or her lower extremities in any suitable way while using the chair.

Although specific embodiments of the disclosure have been described, one of ordinary skill in the art will recognize that numerous other modifications and alternative embodiments are within the scope of the disclosure. For example, while various illustrative implementations and structures have been described in accordance with embodiments of the disclosure, one of ordinary skill in the art will appreciate that numerous other modifications to the illustrative implementations and structures described herein are also within the scope of this disclosure.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments.

What is claimed is:

1. A chair comprising:
a base configured to rest on a surface, the base defining a vertical axis of the chair;
a seat configured to support a user thereon; and
a seat support assembly disposed between the base and the seat in the direction of the vertical axis, the seat support assembly comprising:
a height adjustment assembly configured to allow the seat to translate along the vertical axis;
a wobble assembly configured to allow the seat to tilt relative to the vertical axis in a side-to-side direction, the wobble assembly comprising a wobble lock having a locked configuration, in which the wobble lock inhibits tilting of the seat relative to the vertical axis in the side-to-side direction, and an unlocked configuration, in which the wobble lock allows tilting of the seat relative to the vertical axis in the side-to-side direction.

2. The chair of claim 1, wherein the wobble assembly is further configured to allow the seat to tilt relative to the vertical axis in a front-to-back direction, wherein the wobble lock inhibits tilting of the seat relative to the vertical axis in the front-to-back direction when the wobble lock is in the locked configuration, and wherein the wobble lock allows tilting of the seat relative to the vertical axis in the front-to-back direction when the wobble lock is in the unlocked configuration.

3. The chair of claim 1, wherein the wobble assembly is further configured to allow the seat to tilt relative to the vertical axis in a plurality of directions other than the side-to-side direction and the front-to-back direction.

4. The chair of claim 1, wherein the wobble lock comprises:
a lock protrusion; and
a wobble activation lever configured to move between a locked position, in which a portion of the wobble activation lever engages the lock protrusion, and an unlocked position in which the portion of the wobble activation lever is disengaged from the lock protrusion.

5. The chair of claim 1, wherein the wobble assembly further comprises:
a wobble housing;
a wobble pin disposed at least partially within the wobble housing; and
one or more resilient members disposed within the wobble housing and at least partially surrounding the wobble pin;
wherein the wobble pin is configured to tilt relative to the wobble housing when the seat is tilted relative to the vertical axis, and wherein the one or more resilient members are configured to be resiliently deformed by the wobble pin when the seat is tilted relative to the vertical axis.

6. The chair of claim 1, wherein the wobble assembly is disposed between the height adjustment assembly and the seat in the direction of the vertical axis.

7. The chair of claim 1, wherein the height adjustment assembly comprises a hydraulic cylinder.

8. The chair of claim 1, wherein the height adjustment assembly is coupled to the base in a manner such that the seat is configured to rotate about the vertical axis.

9. The chair of claim 1, wherein the seat support assembly further comprises a first tilt assembly configured to allow the seat to tilt relative to the vertical axis in a front-to-back direction while inhibiting tilting of the seat relative to the vertical axis in the side-to-side direction, the first tilt assembly comprising a first tilt lock having a locked configuration, in which the first tilt lock inhibits tilting of the seat relative to the vertical axis in the front-to-back direction, and an unlocked configuration, in which the first tilt lock allows tilting of the seat relative to the vertical axis in the front-to-back direction.

10. The chair of claim 9, wherein the first tilt assembly is disposed between the height adjustment assembly and the wobble assembly in the direction of the vertical axis.

11. The chair of claim 9, wherein the seat support assembly further comprises a second tilt assembly configured to allow the seat to tilt relative to the vertical axis in the front-to-back direction while inhibiting tilting of the seat relative to the vertical axis in the side-to-side direction, the second tilt assembly comprising a second tilt lock having a locked configuration, in which the second tilt lock inhibits tilting of the seat relative to the vertical axis in the front-to-back direction, and an unlocked configuration, in which the second tilt lock allows tilting of the seat relative to the vertical axis in the front-to-back direction.

12. The chair of claim 11, wherein the second tilt assembly is disposed between the wobble assembly and the seat in the direction of the vertical axis.

13. The chair of claim 11, wherein the first tilt assembly is configured to allow the seat to tilt relative to the vertical axis in the front-to-back direction over a first range of motion, and wherein the second tilt assembly is configured to allow the seat to tilt relative to the vertical axis in the front-to-back direction over a second range of motion that is different from the first range of motion.

14. The chair of claim 1, further comprising:
a seatback configured to support the user's back thereon, the seatback coupled to the seat and configured to tilt along with the seat relative to the vertical axis in the side-to-side direction; and
a pair of armrests configured to support the user's arms thereon, the armrests coupled to the seat and configured to tilt along with the seat relative to the vertical axis in the side-to-side direction.

15. The chair of claim 1, further comprising an extension arm assembly configured to be removably coupled to the base, wherein the extension arm assembly is configured to extend upward from the base and away from the seat when the extension arm assembly is coupled to the base, and wherein the extension arm assembly comprises a pair of handles configured to be grasped by the user's hands.

16. A chair comprising:
a base configured to rest on a surface, the base defining a vertical axis of the chair;
a seat configured to support a user thereon;
a seat support assembly disposed between the base and the seat, the seat support assembly comprising:
a height adjustment assembly configured to allow the seat to translate along the vertical axis;
a tilt assembly configured to allow the seat to tilt relative to the vertical axis in a front-to-back direction, the tilt assembly comprising a tilt lock having a locked configuration, in which the tilt lock inhibits tilting of the seat relative to the vertical axis in the front-to-back direction, and an unlocked configuration, in which the tilt lock allows tilting of the seat relative to the vertical axis in the front-to-back direction; and
an extension arm assembly configured to be removably coupled to the base, wherein the extension arm assembly is configured to extend upward from the base and away from the seat when the extension arm assembly is coupled to the base, and wherein the extension arm assembly comprises a pair of handles configured to be grasped by the user's hands.

17. The chair of claim 16, wherein the extension arm assembly comprises a plurality of pins, and wherein the base comprises a plurality of holes configured to removably receive the pins therein when the extension arm assembly is coupled to the base.

18. The chair of claim 16, wherein the extension arm assembly further comprises:
one or more leg support bars configured to support the user's legs thereon; and
one or more foot support bars configured to support the user's feet thereon.

19. The chair of claim 16, wherein the base further comprises:
a hub centered on the vertical axis;
a plurality of first legs extending outward from the hub, each first leg having a first length from a base end to an opposite free end of the first leg; and
a pair of second legs extending outward from the hub, each second leg having a second length from a base end to an opposite free end of the second leg, wherein the second length is greater than the first length.

20. The chair of claim 19, wherein the base further comprises a horizontal support extending between the free ends of the second legs.
